(19) United States
(12) Patent Application Publication
(10) Pub. No.: US 2004/0066023 A1
(43) Pub. Date: Apr. 8, 2004

(54) Advanced weight responsive supplemental restraint computer system

(76) Inventor: Tabe Joseph, Silver Spring, MD (US)

Correspondence Address: Tabe Joseph, 525 Thayer Ave. # 315, Silver Spring, MD, 20910, US

(21) Appl. No.: 09/959,502

(22) Filed: Oct. 18, 2001

Related U.S. Application Data
(63) Continuation-in-part of application No. 09/692,096, filed on Oct. 20, 2000.
Application No. 09/692,096 is a continuation-in-part of application No. 09/692,098, filed on Oct. 20, 2000.

(51) Int. Cl. B60R 21/32

(52) U.S. Cl. 280/735

(57) ABSTRACT

A supplemental passenger restraint system including a load cell (15) mounted between the seat-mounting surface and the floor of the vehicle for sensing the weight of a siting occupant (110). A controller (25) controls an air bag (1, 2) such that the air bag (1, 2) is deployed at a rate corresponding to the weight of the occupant (110). A controller (75) for said supplemental restraint system wherein the controller is dependent on an occupant's presence for measuring the crash severity and the speed of the vehicle to enable single or plurality of airbag deployments. Such that, when a collision is sensed at the collision sensor (75), the collision sensor (75) will enable the control module (25), which will then enable the amplifier (20) to amplify the accelerometer microprocessor (150), the release gas control processor (130), and the current igniter (55) to ignite the released igniting gas (65) inside the combustion chamber (101). Such that, the force created during the gas ignition inside the combustion chamber correspond to the deployment force of the air bag (1,2) during collision, whereby said force is precisely controlled by the weight of the occupant (110) and the speed of the vehicle.

### 1. FIELD OF THE INVENTION

The present invention relates generally to passenger vehicle supplemental restraint systems commonly known as air bags. More specifically, the present invention relates to a supplemental restraint system for determining weight of a vehicle seat occupant indicative of the output signal of the sitting occupant applied weight on the surfaces of the seat and the floor of the vehicle and enables the control of deployment force reaction of the said safety restraint system which is sensitive to a calculated passenger weight.

Definitions

Load cell (15): Machined high strength steel beams with strain gages (11) bonded inside. A sensing device that houses electrical resistance element or device, for transforming humans body weight into electrical energy and coordinate electromechanical reactions, and is mounted between the mounting surface of the occupant's seat and the floor of the vehicle for sensing the occupant's weight information.

Strain gage (11): Electrical resistance element. A device used to measure the accurate weight of the occupant.

Specialized arrays: Help manage the flow of data about the occupants and the like in the computer memory.

Microprocessors: Follow the instructions of a computer programmer to manage and direct the command flow.

### 2. BACKGROUND OF THE INVENTION

The advantages of the supplemental restraint system, in passenger vehicles, in combination with the use of seat belts have been well appreciated. Air bags are among the most successful safety devices in motor vehicles today. The use of air bags in modern vehicles is fast becoming an absolute standard.

Recently, however, a problem has arisen which presents both real and perceived hazards in the use of air bags. Air bags are primarily designed for the benefit of adult's passengers. When children or infants are placed in the front passenger seat, deployment of an air bag could cause, and has caused, serious injury. Automobile manufacturers, realizing this hazard, have recommended that children and infants only ride in the rear passenger seats of the automobile. According to the National Highway Transportation Safety Board, “smart” technology air bags should be in place by automakers starting with the 1999 motor vehicles. In short, “smart technology” air bags adjust air bag deployment to accommodate the specific weight considerations of the passenger who would be affected by its deployment. The end result is that small passengers are not injured by the deployed air bag.

While air bags have been credited with saving thousands of lives, the tremendous force of the air bag deployment has proven that injuries often result from these expensive measures to promote safety. Air bags have been blamed for deaths of many children and adults in low-speed accidents that they otherwise would have survived. Placing infants and small individuals in the front passenger seat of automobiles has led to some serious, but avoidable, tragedy. Unfortunately these accidents have had a secondary effect in that the public is beginning to perceive air bags as inherently dangerous and, therefore should be selectively disabled, if installed at all. In light of the statistics, air bags have provided a net life saving, thus the solution to the above problem should be less drastic than termination of same, in other to prevent them from injuring younger passengers.

Inevitably, children will be placed in the front passenger seat of automobiles, whether this is due to ignorance of the hazards, or simply due to the necessity of fitting a number of passengers in a particular vehicle. Therefore, the solution lies in adapting the supplemental restraint system to adjust deployment the force to compensate for the presence of smaller passengers. It should be noted that, while less likely, smaller adults also may be injured by the deployment of an air bag. The most obvious solution to the problem, and one, which the public seems to be demanding if air bags are to be used at all, is that the operator of the vehicle has the opinion of disabling the air bag. This solution has several problems. First, inevitably, the operator may forget to disable it when it should be. Second, the operator may forget to enable the system when desired for adult passengers. Finally, entirely disabling the system deprives children and smaller passengers of the benefits of air bags.

In order to avoid some of the above problems related art devices have incorporated measurement systems into the seats of some vehicles to gather information about the passenger and to operate the air bag in accordance with that information. These systems generally represent a simple “on” or “off” selection. First, if a passenger is not located in the seat, or does not trigger certain secondary detectors, the restraint system is disabled. If the detector properly senses a passenger, the air bag is simply “enabled”. This is exemplified by U.S. Pat. No. 4,806,713, issued Feb. 21, 1989, to Krug et al., which shows a seat contact switch for generating a “seat occupied” signal when an individual is sensed atop a seat. The Krug et al. Device does not have the ability to measure the mass of the seated individual. U.S. Pat. No. 5,071,160, issued Dec. 10, 1991, to White et al., provides the next iteration of this type of system. A weight sensor in the seat, in combination with movement detectors, determines if it is necessary to deploy an air bag. If an air bag is deployed, the weight sensor determines what level of protection is needed and a choice is made between deploying one or two canisters of propellant. First, the weight sensor is located in the seat itself, which inherently leads to inaccurate readings. Second, the level of response has only a handful of reaction levels, thus a passenger not corresponding to one of these levels may be injured due to improper correlation of deployment force used to inflate the air bag. U.S. Pat. No. 5,161,820, issued Nov. 10, 1992, to Vollmer, describes a control unit for the intelligent triggering of the propellant charge for the air bag when a triggering event is detected. Vollmer's device provides a multiplicity of sensors located around a passenger seat so as to sense the presence or absence of a sitting, standing, or kneeling passenger. The Vollmer device is incapable of sensing varying masses of passengers and deploying the air bag with force4 corresponding to the specific passenger weight. Rather, the Vollmer seat and floor sensors ascertain whether a lightweight object, such as a suitcase, is present or a relatively heavier human being. None of the above inventions and patents, taken either singly or in combination, teaches or suggests the present invention.

### SUMMERRY OF THE INVENTION

The present invention is designed to deploy an air bag intelligently through the use of weight sensors. The applicant has recognized that there are two points of concern relative to air bag deployment, both centering around the concept that the force of air bag deployment can cause as much injury as an actual auto accident collision (without the protection of air bag). First, the passenger's weight must be determined accurately. Second, once an accurate measure of the passenger's weight has been ascertained, air bag deployment must be controlled to apply an amount of force appropriate to protecting the passenger. There are many unique advantages over prior arts that enable the present invention to solve the long existing problems of the air bag deployment force. Some of the advantages are:

The initial weight of a seating occupant and a changing occupant when exiting is precisely monitored. Thus, the weight of the occupant precisely controls the deployment force.

A control module is dependent on the occupant's presence and the crash severity to decide which airbag to deploy when an accident is sensed.

The EPROM controls the information about a changing occupant at the address line.

Thus, vibrations caused by bumps do not disturb occupant's weight information at the memory.

The address line, which is a referenced storage memory that stores the occupant's actual weight at the initial sitting, does not allow data changes due to vibration or occupant movement on the seat. Once the weight is referenced to the address line, it will be protected from shocks and vibrations, and also prevent data changes when the occupant is sensed moving while the vehicle is in motion.

Even if the occupant's body moves while the vehicle is in motion, the EPROM will only replace the address line information when the occupant completely leaves the seat.

Drivers can verify or check the airbag functionality by simply pushing in on the check button switch.

The occupant's weight information from the load cell sets the accelerometer to deploy the airbag with a force that is dependent on the occupant's weight while the activation of the collision sensor is dependent on the crash severity. The system's intelligence is unique and deployment is smart.

The accelerometer microprocessor is amplified only when the collision sensor senses collision of a structurally preset magnitude. The collision sensor is activated only when a collision force capable of causing injuries is sensed. The deployment force is controlled by the occupant's weight.

The deployment acceleration is directly proportional to the weight of the occupant and variable deployment is ascertained.

The detection of rear end collision and timely deploying an airbag in response is imminent.

The software is programmed to communicate with the driver to further eliminate the usual uncalled behaviors of seating occupants. Thus, the system is occupant friendly.

The discharging of igniting gas and the gas igniter are controlled by the weight information of the occupant on the seat to ensuring a more secured and less destructive deployment force for children of varying ages and sizes. Accordingly, the present invention provides controlled air bag deployment with regard to the mass of the passenger. A load cell underneath a passenger seat senses the weight of a passenger at regular intervals. The load cell accurately determines passenger weight, as opposed to seat sensors embedded within the seat cushion which provide a “passenger present” signal. Further, the present invention discloses a mechanism for providing controlled air bag deployment based on the mass of the passenger. In this regard, the mechanism variably controls the amount of gas in a combustion chamber, which propels the air bag. The air bag can deploy with as little or as much force as is appropriate based upon the passenger's weight.

This improvement is based on the same concept as the provisional application No. 60/079,496 filed on Mar. 26, 1998 and of PCT number US99/0666. The use of the elements disclosed in this invention is designed to improve on the calculated speed of the air bag reaction to the occupant's weight value and the speed of the vehicle from the accelerometer when the vehicle is involve in a collision of a prescribed magnitude or above. In addition, this improvement deals with lots of transistorized switches and other elements like chips and processors. The preferred embodiment of this technology, which is referred to as invention, includes the known standard configuration for all types of air bags. That is, this technology is used to variably control the deployment force on frontal air bags, ceiling air bags, side door air bags and rear seating air bags with a controlled energy from the accelerometer. The general description of this invention as it is further described includes all the above mentioned air bags. Included in the invention are erasable memory chips that are lodged safe and secured inside hard plastic or ceramic shells that are easy to handle and assemble into legions of digital devices to monitor the changing occupant's weight information. In parts; a chip motherboard is used, which includes a machined microprocessor nerve center, where all activities of the occupants and the like are sent for processing. All the chips are protected within some rectangular slabs or modules. The module varies conspicuously in external dimensions and in number of contact points with copper paths that conduct large data and power throughout the circuit board with a minimum of control energy. However, though different types of control module may be employed in this improved technological advancement, only the thyristor will be mentioned for the purpose of limiting order of a control module. The thyristor is a silicon-controlled rectifier, which can be turned on at any point in the data computing cycle. Accordingly, a current pulse is applied to the gate to start the conduction process once the load cell senses an occupant. Once the conduction is started, the pulse is no longer necessary; the silicon controlled rectifier will remain in conduction until the current goes to “0”, which is an indication that there is no occupant on the seat. In all, the silicon controlled rectifier is so important in this invention because of the fast switching speed needed to keep the microprocessors informed about the occupant's presence and the severity of the crash to initiate the initial deployment of the air bag. Intelligently, the silicon controlled rectifier works very closely with the computer logic circuit board. The computer microprocessors of this invention reside inside a long narrow slab and mounted behind the socket that accepts information from the load cell data output. That is, the presence of the occupant is input to the load cell. The weight of the occupant is output from the load cell to the control module. The control module, which is a silicon-controlled rectifier that is used as gate arrays, helps in managing the flow of data from the load cell to the central processing unit (CPU). Small chip modules are scattered about the computer to help ease communication between the board's main functions. The main memory of this computer device is mounted in the motherboard. This memory will always be recognized as parallel ranks of identical modules. Another type of chip used in this device is the EPROM (erasable programmable read only memory). This chip holds information fundamental to the operation of this device [The Advance Weight Responsive Supplemental Restraint Computer System]. The information or data about a changing occupant (110) is controlled at the address line by this chip, which is located inside the CPU and contains the operating software. The chip module connectors or pins are plug into sockets soldered to the motherboard. The EPROM Sockets are pressed into a hole in the board before soldering. When an occupant takes the seat, this chip will send all the output information about the occupant to the address line to initiate the operating software. The chip module is made of wires that are as fine as silk arch, gracefully forwarded from the ends of the pins to square contact pads that line the periphery of the chip. These wires are fused by heat to the pins and contact pads, which are connected through microscopic amplifier circuits, to the rows and columns of the memory cells that cover the chip. The amplifier is designed to amplify the entire device for more speedy output to the accelerometer. There are empty pads between the wires that are used for testing the chip, reprogramming, or as spares in the event that a pad proves faulty. The module is tightly sealed against the entry of moistures and other contaminants. Contaminants could corrode the delicate wires and interrupt the flow of electrical signals from the chip to the pins.

Another element used in this device in the place of the element used to calculate the passenger's mass, or any calculation necessary for the safe deployment of the air bag is the Central Processing Unit (CPU). The CPU is the brain, the messenger, and the boss of the microprocessor of this device. The Random Access Memory (RAM) will take load cell data about the occupant (110) from the address line and turn over to this central processing unit to manipulate. The central processing unit will then use this information to calculate the passenger's mass and any other information needed to feed the accelerometer microprocessor. This processor will use the information from the CPU to adjust the accelerometer crystals to generate a controlled energy for the speed and acceleration. This speed and acceleration is proportionate to the load cell output weight value of the occupant and the occupant's calculated mass for the safe and proper deployment of the air bag. The same information from the CPU will then be used by the canister microprocessor to adjust the sliding pot and the gas release valve to release a proportionate amount of gas. The said released amount of gas, when ignited by the gas igniter, will deploy the air bag at a speed and force that are proportional to the occupant's weight, without causing any further injury. However, there are other processors that are inside this computer that handles the signals coming from the CPU to the accelerometer to duplicate the same effect and compare with the accelerometer microprocessor before the deployment is initiated upon collision. These processors will get the passenger's weight information, process the information quickly in less than a millisecond, and signal the accelerometer to generate a controlled energy that will determine the exact acceleration needed to influence deployment when the collision sensor senses a collision of said prescribed magnitude. All the operations of the processors are done by signals, turning on or off different combination of switches. The processors will handle the arithmetic logic unit that handles all the data manipulations. The processors are connected to the RAM through this computer device motherboard or bus. The bus interface unit will receive data and coded instructions from the computer RAM. Data will travel into the processor 10 bits at a time. The branch prediction unit will then inspect the instructions to decide on the logic unit. The decode will then translates the response from the load cell into the instructions that the Arithmetic Logic Unit can handle. If decimal point numbers exist, the internal processor will kick in to handle the numbers. The Arithmetic Logic Unit (ALU) will receive instructions up to 10 bits at a time. The A LU will process all its data from the electronic scratch pad or register. All results will then be made final at the RAM.

The module links are made of gold to resist corrosion from dampness that might enter the module, despite precautions. When the key switch of the vehicle is turn on, a burst of electricity of about 5 millivolt will energize the load cell. When an occupant takes on the seat, the load cell will use the input energy from the occupant's body to start strings of events that will be sent to the computer device memory for processing and calculations. This input from the occupant's body will be received by the load cell as force energy. The load cell will then output the force energy as weight and send to the control module to identify the seat that has the occupant. When there is no occupant on the seat, the control module will further check to make sure that there is no person on the seat. That is, the control module will recognize the weight of the seat and the 5 millivolt. Any additional weight will cause the control module to send immediate signal to the CPU to calculate the mass. The control module will then signal other processors to program the computer device to transmit signals for the proper air bag deployment force and speed. Always, the CPU will first check for the program functions and workable parts. If the CPU finds any unworkable part, it will send a human voice audio message out to let the driver no of the problem before hand. That is, the air bag will not deploy until repairs are made to safe guard the occupants. The deployment of the air bag when an unworkable path is found may further cause injuries to the occupant. However, there is a periodic functional check button for the air bag that is installed on the driver's side of the dashboard. When the driver starts the car, before he drives away or engage the vehicle in motion, he can always use this check button to check and make sure that all the air bags and their components are workable. The test results will be accomplished with audio broadcasting human voice signals for the specific test result read out. When the CPU complete it's test, it will receive a program from the application software that will tell the CPU how to carry on the tasks faster and more accurately. The CPU is of a tabula Rasa, which can make it capable of handling any task in the supper smart air bag control creation. The microscopic switches in the heart of the microchips would let the CPU transform the force energy behavior coming from the occupant's body input to the load cell, which is then output to the control module as weight. The weight value will then be transmitted all the way to the accelerometer processor that will energize the crystals to generate a proportionate amount of energy. The accelerometer mass, which is dependant on the said energy generated by the crystal, will move to a distance D when the voltage generated by the crystals is acted upon its body. The energy generated by the crystal is equal to the force needed to move the mass body to the distance D. The distance D, which the mass moved to, is equal to the distance contracted by the accelerometer spring. The weight of the occupant, the energy generated by the crystal, the force acting on the accelerometer mass, and the contracting force acting on the spring are all proportionate, while the distance D that the mass moved to is proportionate to the distance contracted by the spring. The contraction of the accelerometer spring determines the deployment acceleration and force of the air bag. The weight value from the load cell is the same weight value that, when processed, will be used to energize the air bag sliding pot and gas release valve to adjust to the released gas which, when ignited, will influence the rate of deployment that is proportional to the said weight value. The force energy created by the ignition of the gas inside the combustion chamber is proportionate to the contracting force of the accelerometer spring. The energy generated by the combustion also determines the force of the deployment. This intelligent device, with all the microscopic switches, will constantly be flipping on and off in time to a dashing surge of electricity. In addition, the operating system will take on more complicated tasks when the ignition switch is turn on. This includes making the hardware interact with the software to make sure that all the memories are workable.

The boot manager will assume control of the start up process and loads the operating system into ROM. The operating system chip works with the BIOS to manage all operations, execute all programs, and respond to all signals from the hardware. Lots of transistors are used in this device to create binary information for logical thinking inside the computer. If the current passes, the transistor will create a“1” and the system will run through a post. If there is no current, the transistor will create a“ 0”. The 1s and 0s are the bits used as on off switches through out the logic. This computer device will be able to create any number to match the occupant's weight, provided it has enough transistors grouped together to hold the 1s and 0s required. The computer is a 10-bits computer. That means it will handle binary numbers of up to 10 places or bits to make it faster. The bits will stand for true (1) or not true (0), which will allow the computer to deal with Boolean logic. The transistors will be configured in various ways or logic that is combined into arrays called half adders and full adders. Most transistors are needed to create the adder that can handle the mathematical operations for up to 10 bit numbers as called by design. These transistors will make it possible for a small amount of electrical current to control a much stronger current in a millisecond. The transistors will also be able to control a more powerful energy through the load cell to the accelerometer in a millisecond during collision. Thousands of transistors will be combined on a single slice of silicon. A small positive electrical charge of 5 milivolts will be sent down through an aluminum lead that runs into the transistors. This charge will be transferred to a layer of conductive polysilicon buried in the middle of a non-conductive silicon dioxide. The positive charge will then attract negative charge electrons out of the base of the positive silicon that separates two layers of the negative silicon. The electrons will rush out of the positive silicon, creating an electronic vacuum filled by electrons rushing from another conductive lead called the source. The electrons from the source will flow to a similar conductive lead called the drain in addition to filling the vacuum in the positive silicon, there by completing the circuit. This completion of the circuit will turn a transistor on so that it will represent a 1 bit. If a negative charge is applied to the polysilicon, electrons from the source will be applied and the transistor will turn off. The transistors used for this device are combined on a single slice of silicon. The slice is embedded in a piece of plastic and attached to metal leads that expand to a size that makes it possible to connect the chip to other parts of a computer circuit. The leads carry signals into the chip and send signals from the chip to other computer components.

When the key switch is turn on, an electrical signal of 5 milivolt will energize the load cell before it gets to the computer. When it gets to the computer, it will follow a permanently programmed path to the CPU to clear left over data about the previous occupant (110) from the chips internal memory registers. This electrical signal will reset the CPU register called program counter to a specific number. This number will tell the CPU the address of the next instruction that needs processing. The measured weight of the occupant will be read by the load cell, then transform from analog to digital before sending to the address line in a set of read only memory chip that contains this computer device basic input and output system “BIOS”. As the key switch is turned on, the post will check all the hardware components' functionality. The boot program on this computer device ROM and BIOS chip will check to see if there is any occupant on any of the seats. The program will then send the occupant's information on weight to the address. If there is no person on any of the seat, the program will check any additional weight. If the weight is less than 10 lb, the program may send undeployment message to the address. The boot program, by checking for occupant's present from the load cell to the RAM, will read all the information about the changing occupant's weight. The information about the changing occupant will constitute the occupant's new deployment force and speed of the air bags. That is, the occupant's weight will energize enough code that will activate the calculation of the occupant's mass, speed of the airbag, and deployment force that depend on this controlled energy. After all the calculations are done, the results will then be recorded into the memory at the tri-decimal address 3C00. The basic input output system will then pass the information control to the boot by branching to this address.

When a person is on the seat, the load cell will energize the operating system. The operating system will then send a burst of electricity along an address line that will represent the occupant's weight. The address line is a microscopic strand of electrically conductive material etched onto the RAM chip. The burst identifies where to record data among the address lines in the RAM chip. At each memory location where data can be stored, the electrical pulse will close a transistor that connects to a data line. These transistors, like all the other transistors, are microscopic electrical switches. When the transistors are closed, the load cell will send burst of electricity along selected data lines. Where each burst will represent either a 1 or a 0 bit. When the electrical pulse reaches an address line where the transistor is closed, the pulse will flow through the closed transistor and charges the capacitor. The capacitor, which is an electronic device that stores electricity, will then let the process restarts to refresh the data with the exact value of the occupant's weight. When the occupant leaves the seat and all the other seats empty, the computer will then turn off the process. Each charged capacitor represents a 1 bit. While the uncharged represent a 0 bit.

The device also utilizes a post, which is a self-test that ensures that the hardware components and the CPU are functioning properly before any information is process and sent to the address. The CPU uses the address to find and invoke the read only memory that will get all the information about the passengers from the load cell and send to the basic input and output system program. The CPU will send all these signals over the system bus, to make sure that they are all functioning properly. In addition, the CPU will also check the system's timer to make sure that all the operational functions are synchronized. The CPU will write data to each chip then read it and compare what it reads with the data it sent to the chip at first. A running account of the memory information is sent to the accelerometer processor that will message the crystals in the accelerometer to set to the desired acceleration that is dependant on the occupant's weight information. The accelerometer input will then be used to control the energy needed to initiate variable deployment force of the air bag. The post will send signals over specific paths on the bus to the load cell and check for the weight signal or response to determine the occupant's actual weight. The results of the post reading will always be compared with in the CMOS. CMOS is the memory chip that retains its data when an occupant (110) is replaced. The operating system lets this computer device read different signals from the load cells. The microchip contains the operating system that lets this computer device perform all assigned tasks by running the operating system for an alternative function.

The software will read data stored in the RAM through another electrical pulse sent to the address line, closing the transistors connected to it. Every where along the address line that there is a capacitor holding a charge, the capacitor will discharge through the circuit created by the closed transistors, there by sending electrical pulses along the data lines. The RAM (Random access memory) chips are so important in this device because the computer will move the processed information about the occupant's weight from the address to the RAM. All the information and data are stored in RAM before the processor can manipulate the data. All data in the computer exist as 0s and 1s. An open switch represents a 0, while a closed switch represents a 1. When the key switch is turned on, RAM is a blank slate. The memory is filled with Os and Is that are read from the load cell to the address. When there is no occupant on the seat, every data in RAM will disappear. The software will recognize which data lines the pulses are coming from, and interprets each pulse as a 1. Any line on which a pulse is not sent is represented as a 0. The combination of 1s and 0s from eight data lines will form a byte of data. The RAM functions as a collection of transistorized switches for the control room of this device intelligence. The 1s and 0s, which is an on and off switch, are used to control displays, and can also be used to add numbers by representing the“ 0s” and the“1s” in the binary number system. This binary number system will allow the computer to do any other form of math. Everything in the computer, math's, words, numbers software instructions will communicate in the binary numbers. That means all the switches (transistors) can do all types of manipulation.

The clock inside the computer regulates how fast the computer should work, or how fast the transistorized switches should open or close. The faster the clock ticks or emits pulses, the faster the computer will work. The speed is measured in gigahertz, which are some billions of ticks per second. Current passing through one transistor may be used to control another transistor; in effect turning the switch on and off to change what the second transistor represents as a logic gate. Accordingly, it is a principal object of the invention to provide a supplemental restraint system having an accurate weight sensor to determine the presence and weight of a passenger.

It is another object of the invention to provide a correlation between the weight of the passenger and the deployment characteristics of the air bag.

It is a further object of the invention to provide an air bag deployment system, which is infinitely variable between an upper and lower threshold, to positively correlate the force of the air bag to the force of a moving passenger.

Still another object of the invention is to prevent the deployment of an air bag when no passenger is present.

Yet another object of the invention is to provide a mechanism to detect the imminence of a rear impact and to timely deploy an air bag in response thereto.

It is an object of the invention to provide improved elements and arrangements thereof in an apparatus for the purposes described which is inexpensive, dependable and fully effective in accomplishing its intended purposes.

These and other objects of the present invention readily will become apparent upon further review of the following specification and drawings.

### BRIEF DESCRIPTION OF THE DRAWINGS

FIG. 1 is seen to represent a side view of a passenger (110) on a seat (10) of a vehicle using plurality of load cells (15) mounted between the seat mounting surface and the floor of the vehicle to control deployment of the supplemental restraint system of the present invention.

FIG. 2 is seen to represent the transistorized switches (04) and a block diagram of the primary components of the supplemental restraint system of the present invention.

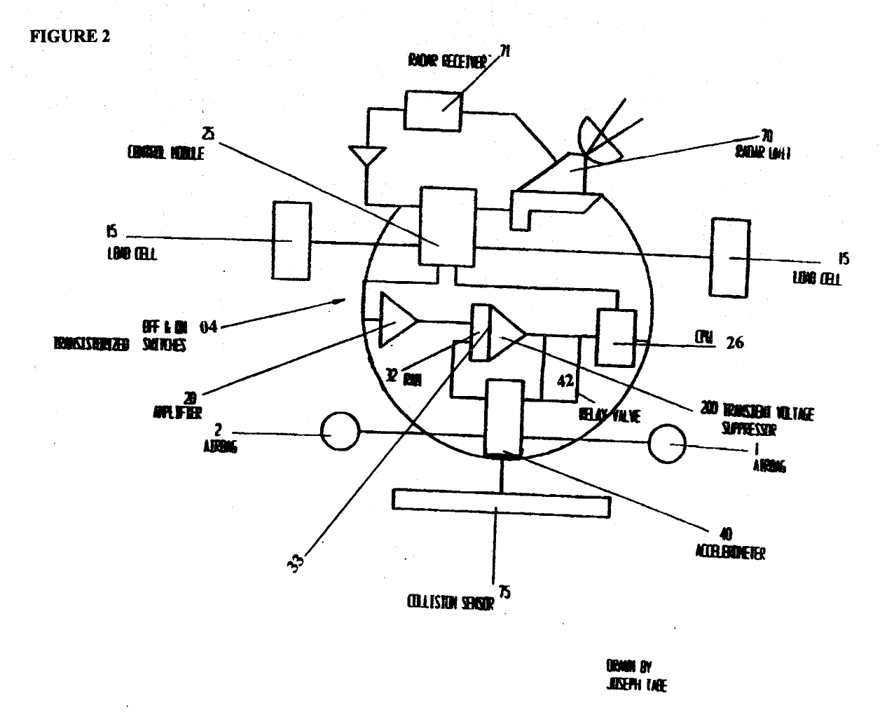

FIG. 3 is seen to represent a sectional view of the load cell (15) showing the strain gages (11), and a circuit diagram of the components of the present invention.

FIG. 4 shows the gas canister (60), the sliding pot (61), and the deployment components of the present invention.

FIG. 5 is seen to represent the interior of the vehicle showing the airbags (1, 2), the dashboard (300), and the pressure sensor (310) mounted on the dashboard for signal communication when active.

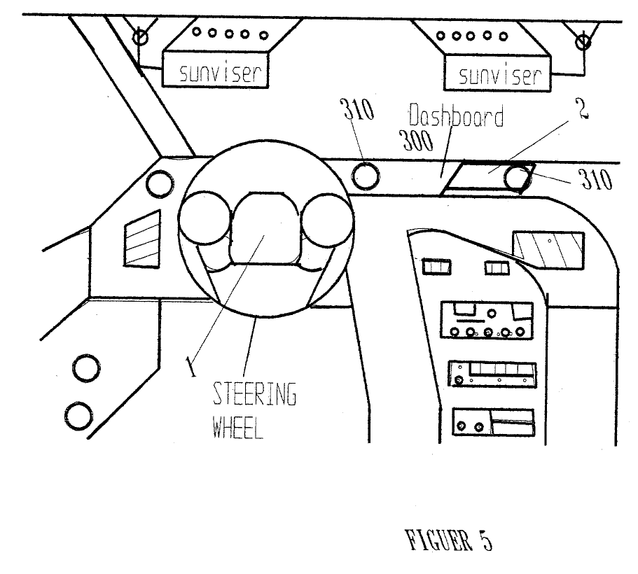

Similar reference characters denote corresponding features consistently throughout the attached drawings.

### DETAILED DESCRIPTION OF THE PREFERRED EMBODIMENT

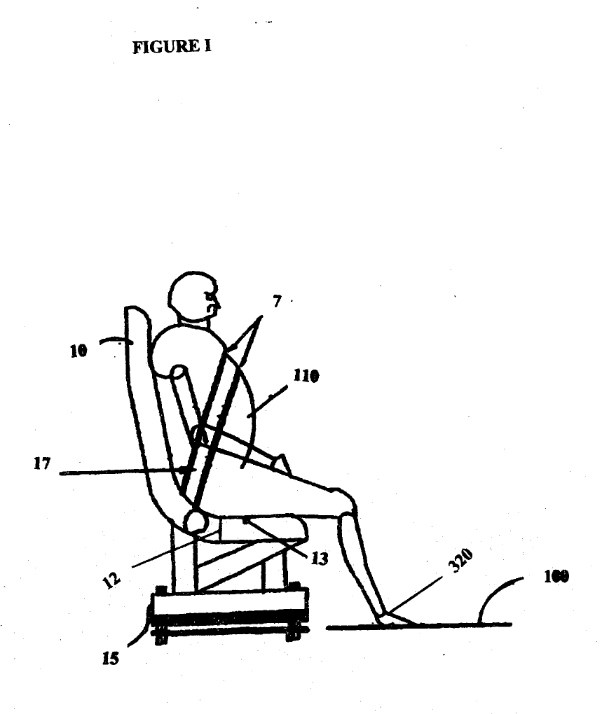

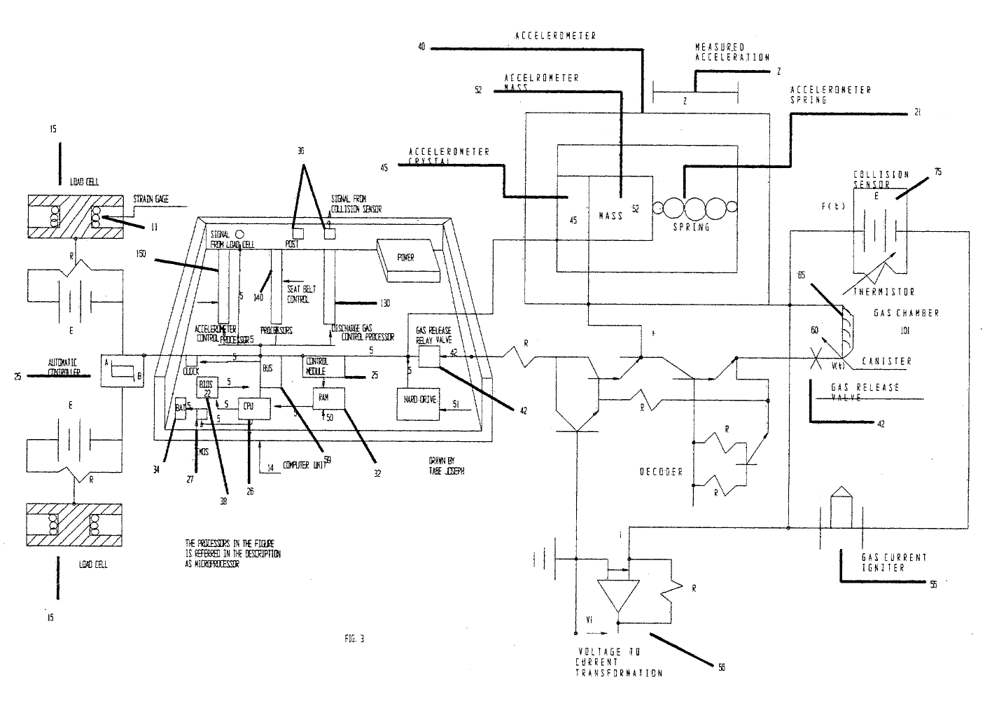

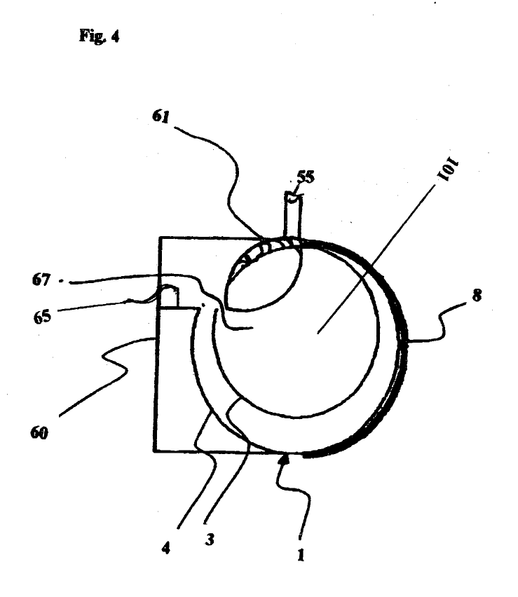

With reference to the accompanied figures, FIG. 1 reference number 12 and 100 are shown to represent the cushioning (12) and the floor (100) respectively. In FIG. 3, the reference number 15 is seen to represent load cells mounted beneath the two front seats. In FIG. 3, the accelerometer spring (21), the accelerometer (40), the accelerometer crystals (45), the accelerometer mass (52), the gas current igniter (55), and the measured acceleration (Z) are seen to represent components of the accelerometer. The reference number (65) is seen in FIG. 4, to represent the igniting gas. The reference number (67) shown in FIG. 4 is seen to represent the opening (67) into the gas chamber (101). The gas is pressured from the gas canister (60) through the sliding pot opening (67) to the combustion chamber (101) for ignition by the current igniter (55) therein, to initiate a proportionate amount of deployment force of the air bag (1). The accelerometer (40) when amplified by the amplifier (20), sends line signals to the gas canister sliding pot (61) to open to an area (67), enabling the gas release valve relay (42), to release the amount of igniting gas (65), that when ignited by the igniter (55), deploys the air bag intelligently with a force that is proportionate to the weight of the occupant (110). The energy generated by the crystals (45) displaces the accelerometer mass (52) in the accelerometer (40), to generate a corresponding amount of electrical energy therefrom, such as might occur with the piezoelectric accelerometer (40). The applicant also understands that this high accuracy weighing system is also designed to carry in vehicle information about the seating occupant (110). By incorporating a ROM and BIOS (59), a RAM (32), and software program inside the load cell (15), enables recording of any and all the information about the changing occupant (110). The BIOS provides basic control over the load cell (15) and is stored in the ROM (59). The ROM (59), which is a special chip for this computer device, contains instructions and information in its memory that can not be changed, whereas the RAM (32) is primary memory storage for the occupant's information. The piezoelectric accelerometer (40) generates electrical energy when put under mechanical stress. Applying pressure on the surface of the crystal (45) creates the stress. This pressure is initiated by the occupant's (110) applied weight on the seat (10) that will then initiate signals to enable the stress. The electrical energy generated by the crystal (45) will displace the accelerometer mass (52) in the accelerometer (40), and the displacement force will react on the accelerometer spring (21), enabling it to contract to an equal amount. The force reaction on the spring (21) is proportionate to the weight of the occupant (110). When a collision is sensed, the collision sensor (75) will enable the control module (25) which will then enable the amplifier (20) to amplify the accelerometer microprocessor (150), the release gas control processor (130), and the current igniter (55), to ignite the released igniting gas (65) inside the combustion chamber (101). The force created during the combustion is the deployment force of the air bag. The term meter decoder is changed to a decoder. The speed of the vehicle and the collision threshold for the activation of the airbag (1) determines the crash severity and allows the seat belt (10) to lock the occupant (110) in place while the air bag (1) protects the occupant's upper body from moving. The load cell (15) differentiates adults from kids with the highest degree of reliability. The direct weight on the seat surface and the occupant's weight on the floor (100) are transmitted to the load cell (15) to equal the occupant's input or weight. The weight information is kept constant so that even if the occupant moves around the seat, the weight information at the address line (33) will not change. But when the occupant (110) finally leaves the seat, the EPROM (34) will erase the said occupant's weight information from the address line (33). So, when a new occupant (110) is seated, new information will be sent to the address line (33). Accordingly, the parameter of weight for the air bag deployment is precisely determined. With the smart seat belt control system and the advanced weight responsive supplemental restraint computer system, the actual weight of the occupant (110) is measured when the occupant is seated and or belted. There by ensuring that the correct occupant's weight is sent to the CPU to enable calculation of the occupant's mass. As such, the proper deployment force is ensured. Even if the occupant's legs (105) are on the dashboard (300), the weight information will not change, but the occupant's legs (320) will trigger a pressure sensor (310) that will warn the occupant (110) of an unsafe behavior. The warning signal is a human voiced warning signal and will only go off when the behavior is corrected. The advanced weight responsive supplemental restraint computer system could be programmed too, not to deploy when a child's weight is sensed on the front seat. That is, the child's weight could be defined as a weight limit of less than 20 lb, provided the child is properly belted. The smart airbag technology will reduce airbag induce injuries when deployed. Because the deployment force is proportionate to the occupant's weight on the seat (10). By using the load cell (15) to sense the occupant's weight before controlling the deployment of the airbag (1) further eliminate the inherent deficiencies on the present sensing means for the current airbags. The load cell (15) intelligently measures the part of the occupant's weight that is on the floor (100) and the other weight on the seat (10), thereby guaranteeing an accurate measurement of the occupant's weight. In addition, ones the occupant (110) is seated, the exact weight reading of the occupant (110) will be measured and sent to the address line (33). So that when the occupant (110) constantly moves around the seat (10), the weight value at the address line (33) will not change. The EPROM (34) will only change the weight value when the occupant (110) is totally replaced. Accordingly, this is what makes the advanced weight responsive supplemental restraint computer system smarter. If the occupant (110) is properly belted, during high-speed crashes, the occupant (110) will fully benefit from this smart air bag system because the smart airbag will prevent the occupant's upper body from moving. The advanced weight responsive supplemental restraint computer system, together with the smart seat belt control system, further increase the accurate weight reading with the load cell (15) usage. The preferred embodiment of the present invention includes the known standard configuration of the occupant (110) and driver's side air bags (1, 2). It also includes side door and ceiling air bags (1,2), rear seating air bags (1,2), or any air bag that may further be used, for the accurate deployment of such air bags (1,2) based on the weight and mass of the occupant (110). Specifically, more than one load cell (15) may be used to accurately compute the occupant's weight for the accurate deployment of the air bags (1, 2).

Another device that may be used in place of the load cell (15) is the pressurized bag, inflatable bag or inflated bag that could be mounted on the surface of the seat (10) or beneath the seat (10). When an occupant (110) takes the seat (10), the weight of the occupant (110) will displace X amount of the stored pressure to a relay valve (42). The said weight of the occupant (110) will initiate the inflatable air bag to inflate X amount of air to the relay valve (42) that will record the displacement X, or inflation X, as the occupant's weight value. The displaced pressure or inflated air pressure is the maximum pressure that when the collision sensor (75) senses a collision, it will activate the accelerometer (40) which will then initiate a deployment speed and force of the air bags (1,2) that will equal the said maximum displaced pressure X, where the stored pressure is the maximum pressure for the maximum acceleration and deployment force of the air bags (1, 2) that may be initiated when the collision sensor (75) senses a collision of the preset magnitude. The weight of the replacing occupant (110) will displace the stored pressure to an amount X that is equal to the weight value of the said occupant (110). If the weight value max or exceeds the stored pressure, then the acceleration and the deployment force will have a constant value when a collision is sensed. The recorded displacement X will be transformed into a weight unit for the CPU (26) to recognize. The CPU (26) will then carry on the calculations and computations the same way as the load cell (15). Every process is the same from the displacement point X, when comparing the pressurized bag operation with the load cell (15) operation. Accordingly, for more accurate description, only the load cell (15) will be elaborated in the entire description. However, the applicant is claiming the use of any pressurized bag used for restraining. This is for the attempt of trying to adopt said bag to control the deployment force of the air bag (1,2) from the behavior between the said bag and the occupant 110), to prevent any further injury to the occupant (110) during collision.

The air bag system generally comprises the known standard configuration for an occupant (110) and driver's side frontal air bags, all configured in the same manner. When the ignition switch is turn on, an electrical current of 5 milivolt will energize the load cell (15) before the current gets to the computer. When the occupant (110) takes on any of the seats (10), the load cell (15) will use the input energy from the occupant's body to start strings of events that will be sent to the computer device memory (32) to enable data processing and computation. The post (36) inside the computer will then check all the hardware components functionality to ensure that the hardware components and the CPU (26) are functioning properly. The post (36) will later send signals over specific paths on the chip motherboard (38) to the load cell (15) to account for the weight signals or responses to determine the occupant's actual weight value. The input energy from the occupant's body when seated is received as force energy. The load cell (15) will then output the force energy as weight and send to the control module (25) that will then identify the seat (10) that has the occupant (110), before activating the motherboard (38). This chip motherboard (38) is where all activities are sent for processing. The result of the post reading will further be compared with, in the CMOS (27). At the completion of the post (36) readings, the boot program will then check to see if there is any occupant (110) on any of the seat (10). This program will then send the occupant's information on weight to the address line (33). The air bag system generally comprises the known standard configuration for an occupant (110) and driver's side frontal air bags, all configured in the same manner. When the ignition switch is turn on, an electrical current of 5 millivolt will energize the load cell (15) before the current gets to the computer. When the occupant (110) takes on any of the seats (10), the load cell (15) will use the input energy from the occupant's body to start strings of events that will be sent to the computer device memory (32) to enable data processing and computation. The post (36) inside the computer will then check all the hardware components functionality to ensure that the hardware components and the CPU (26) are functioning properly. The post (36) will later send signals over specific paths on the chip motherboard (38) to the load cell (15) to account for the weight signals or responses to determine the occupant's actual weight value. The input energy from the occupant's body when seated is received as force energy. The load cell (15) will then output the force energy as weight and send to the control module (25) that will then identify the seat (10) that has the occupant (110), before activating the motherboard (38). This chip motherboard (38) is where all activities are sent for processing. The result of the post reading will further be compared with, in the CMOS (27). At the completion of the post (36) readings, the boot program will then check to see if there is any occupant (110) on any of the seat (10). This program will then send the occupant's information on weight to the address line (33).

The passenger's seat (10) is mounted on the load cell (15), and bolted between the mounting metal base of the seat (10), and the floor (100) of the vehicle, to provide a solid support and an attaching structural strength. By mounting the seat (10) on the load cell (15) and on a fixed structural support will enable maintaining a precise and accurate loading of the occupant's weight on the said load cells (15). The load cell (15) ascertains the weight of the passenger's seat (10) and any occupants' (110) therein. The load cell (15) can also be calibrated so that the weight of the seat (10) will be the zero point reading. Mounting the load cell (15) between the metal base of the seat (10) and the floor (100) of the vehicle, or on a rigid sliding, or fixed surface, rather than within the passenger's seat (10), the present invention is more likely to obtain an accurate computation of the passenger's weight. Said computation is not subjected to faulty readings due to the other nature and configuration of the cushioning (12) between the thickness of the contact seating surfaces (13) of the passenger's seat (10) and the occupant (110) movement. The load cell (15) weighing system is a high accuracy scale with an in vehicle information system. The applicant understand that the high accuracy weighing system is designed to carry in vehicle information about the occupant (110), by incorporating a ROM or BIOS memory (59), a RAM memory (32), and a software program inside the load cell (15), to record any and all the information about the changing occupant (110). The BIOS provide basic control over the load cell (15) and is stored in the ROM (59). The ROM (59), which is a special chip for the computer device, contains instructions and information in its memory that can not be changed, whereas the RAM (32) is a primary storage for the occupant's information. Accordingly, it will display and record in the memory (32), all the necessary computed weights and also feed the CPU (26) with these information to allow calculation of the mass and other necessary information needed to aid the control of a variable deployment force of the air bag (1,2). The deployment of such air bag (1,2) generates a deployment force, where such generated force, with the use of the present invention, or by incorporating the software program inside the load cell (15), is proportionate to the computed weight of the occupant (110) on the sensed seat (10). The software program enables communication with the driver and the occupant (110) if necessary, to properly protect the occupants (110) from an uncalled behavior when the vehicle is in motion. All the air bags (1, 2) in the vehicle will be supported and controlled by this deployment force control system. Also, there are many complains about passengers not wearing their seat belt (17) when a vehicle is in motion. This malpractice in passenger's daily behaviors has resulted in many fatalities. Yet, the malpractice behaviors are increasing each year. Accordingly, with this smart air bag technology, cars will not be able to start if there is no occupant (110) on any of the seats. However, if there is an occupant (110) in any of the seat (10), the occupant (110) must wear the seat belt (17) for the car to start. If the occupant (110) decides to put on the seat belt (17) just to start the car, as soon as the seat belt (17) is disconnected the engine will cut off. The engine will stay running only when the seat belt (17) are worn in all the occupied seats. In other to make driving more safer, the applicant have realized that, by designing the seat belt (17) to only be disconnected when the engine is not running, passengers will not confront the problem of their kids disconnecting the seat belt (17) while they are driving in the belt way. Therefore, once an occupant (110) in any of the seat (10) wears the seat belt (17), the seat belt (17) will not allow disconnection in any way or form unless the engine is cut off. That is, the seat belt processor (140) will monitor the seat belt disconnection processes and disable signals to the key switch or starting means when an occupant is not belted. That means as long as there is an occupant (110) on any of the seat (10), without the seat belt (17), the engine will not start. Again, if the occupant (110) wears the seat belt (17), he will not be able to disconnect the seat belt (17) until the engine is shut off. The load cell (15), together with this computerized system that supports the control of the air bag deployment, makes the safety of passengers a prime factor. In conjunction with the load cell (15), the seat belt (17) will always be worn at all times. Even if the occupant (110) is on the back seat, without putting the seat belt (17) on the engine will not start. If the driver decides to stop and pick another occupant (110) with the engine running, or if the occupant (110) enters the car and fails to put on the seat belt (17), the seat belt processor (140) will signal the key switch or starting means to cut off. The car will only be able to start when the passenger's buckles-up the seat belt (17). With this advanced technology, the protection of the passengers is addressed on both frontal and rear seating. The load cells (15) are installed on the sensitive seating positions to get the information of the passengers on the rear seats. The load cell (15), which is corrosion resistant high alloy steel with a dynamic load cell capacity of up to 1000 lb or more, is constructed from machined high steel beams with strain gages (11) bonded inside. This load cell (15) is designed for vehicles with air bags (1, 2) or any restraint system like the seat belt (17). The strain gages (11), which are electrical resistance elements, are properly sealed with sealant that will not allow moisture or any contaminant to disrupt the strained information. When the occupant's body is input into the seat where the load cell (15) is bolted underneath, the load cell (15) will process the input information and the weight of the occupant (110) will be applied on the strain gages (11). The strain gages (11) will then be strained to the weight amount of the occupant (15), and the load cell (15) will output this amount as the occupant's weight.

Accordingly, the weight of the occupant (110) will create a reaction force that is being acted upon, and applied on the passenger's seat (10). This applied weight will enable the strain gages (11) to then be strained, compressed, pressured, or stretched in a corresponding amount, causing a change in voltage signal on the connecting lines. As the strain gages (11) are stressed, strained, compressed, or pressured, the effective resistance of the strain gages (11) will vary in an amount corresponding to the strain. The strain thereacross varies in an amount corresponding to the actual weight of the occupant (110). Specifically, the induced voltage across each strain is divided so that a voltage signal is obtained that corresponds to the weight of the occupant (110) on the seat (10) where the gages are strained. The control module (25), which is a silicon control rectifier, will intelligently identify the seat (10) where the weight signal is outputting from, and manage the flow of the weight data to the ROM (59). The ROM (59) will then receive the data about the occupant from the control module (25) and send to the basic input and output system BIOS inside the ROM (59) program to the address line (33). The RAM (32) will then take the load cell (15) data about the occupant (110) from the address line (33) and turn over to the CPU (26) to manipulate. The CPU (26) uses the address line (33) to find and invoke the ROM (59) to insure an accurate calculation of the occupant's mass and any other information needed to feed the accelerometer (40), including tensioning of the seat belt (17) when the impact force is determined. The CPU upon calculating the occupant mass value sends said information to the accelerometer microprocessor (150) that will then use the information from the CPU (26) to process and energize the accelerometer crystal (45). The crystals (45) will then use the processed information from the CPU (26) and the standard 5 milivolts from the starting means to generate a controlled energy for the deployment force control and acceleration that is proportionate to the load cell (15) output weight value of the occupant (110). The crystal (45), by receiving the 5 milivolts energy from the starting means and the information from the CPU (26), will generate force energy on its surface that is proportionate to the occupant's weight. This energy that is generated by the crystals (45) is used to energize the accelerometer mass (52). The accelerometer mass (52) movement, which is dependent on the said energy generated by the crystals (45), will move to a distance D, when energized by the generated voltage from the crystals (45). This energy that is generated by the crystals (45) is equal to the force needed to move the accelerometer mass body to a distance D. The same energy from the crystals (45) is used to energize the canister microprocessor (130) to adjust the sliding pot (61) and the gas release valve relay (42) to adjust to an opening (67) that will initiate a proportionate deployment force. These sliding pot (61) and release relay valve (42) will operate from the generated control energy and a proportionate amount of gas will be released based on this energy amount. The gas current igniter (55) will then ignite the controlled released gas (65) in the combustion chamber (101) to assure the appropriate and safe deployment force. Where the amount of current generated to ignite the controlled gas (65) is proportionate to the voltage generated by the crystal (45). The voltage generated by the crystal (45) goes through voltage to current transformation (56) to initiate the proportionate amount of current to ignite the controlled gas (65) when released. The amount of voltage that is being transformed is the generated energy from the crystal (45), which is proportionate to the weight of the occupant (110). When the gas (65) is ignited, combustion is created inside the air bag (1, 2). The space where the combustion takes place is the combustion chamber (101), and the combustion energy will deploy the air bag (1,2) at a speed and force that is proportionate to the occupant's weight, without causing any further injury. The distance D that the accelerometer mass (52) moved is equal to the distance the accelerometer spring (21) will contract. The weight of the occupant (110), the energy generated by the crystal (45), the force acting on the accelerometer mass (52), and the contracting force of the spring (21) are all proportionate. The distances D that the mass moved is proportionate to the distance the accelerometer spring (21) contract. The contraction of the accelerometer spring (21) determines the deployment force amount and acceleration value of the air bag (1, 2). When an occupant (110) is replaced, the EPROM (34) will control that information at the address line (33). The amplifier (20) will amplify the entire device for a more speedy output to the accelerometer when a collision is sensed of the pre-set magnitude. All the operations of the processors are done by signals, turning on and off different combinations of transistorized switch (04). These processors handle the arithmetic logic unit that handles all the data manipulations and are connected to the RAM (32) through the computer motherboard (38). The motherboard (38) interface unit will receive data and coded instructions from the computer RAM (32). Data will travel 10 bits at a time and the branch prediction unit will then inspect the instructions to decide on the logic unit. The decoder will then translate the response from the load cell (15) into the instructions that the arithmetic logic unit can handle. The ALU will process all its data from the electronic scratch pad or register that is secured on the motherboard (38). All results are made final at the RAM (32).

The load cell (15) serves an initial and secondary purpose. Initially, a base line is developed in conjunction with the load cell (15), representing the weight of only the passenger's seat (10). Once the initial base line is ascertained, during the operation of the vehicle, if the base line amount is not exceeded by a certain amount, the air bag (1,2) is disabled, thereby preventing the air bag (1,2) from being used when an occupant (110) is not present. At this point, the boot program will send a 0 message to the RAM (32) and the RAM (32) will recognize that there is an empty seat (10). The load cell (15) secondarily functions to accurately weigh the occupant (110) when the baseline representing the weight of the passenger's seat (10) is exceeded. This information is then passed on to the control module (25), which will then determine the air bag (1, 2) that should deploy in case the vehicle is involved in an accident. This determination is based on the line signals from the load cells (15) to the control module (25) that will activate other devices to initiate the proper force at which the air bag (1,2) should deploy based on the passenger's weight. Where a control module (25) is defined as a device that transmit load cell (15) output information through its internal encoder. The encoder, which is an analog to digital transmitter, will then transform these load cell (15) output signals from analog to digital and send to the address line (33) as the occupant's weight. The RAM (32) will then receives the digital weight signal from the address line (33) and sends to the CPU (26) for computations. The CPU (26) will then calculate the occupant's mass and also compute all the necessary information needed to control a safe deployment of the air bag (1,2) without causing any further injuries to the occupant (110). All the information is transmitted through line signals, turning on and off different combinations of the transistorized switches (04). The control module (25) will signal the amplifier (20) to amplify the accelerometer processor (150) when a collision is sensed by the collision sensor (75). At this point, the accelerometer (40) will compute the air bag (1, 2) acceleration from the weight and mass information of the occupant (110) at the address line (33). The accurate deployment force at which the air bag (1, 2) should deploy is based on the occupant's weight. The accelerometer microprocessor (150) is amplified when the collision sensor (75) senses a collision of the said magnitude. The acceleration at the deployment point is directly proportionate to the force generated by the weight of the occupant (110). This acceleration is based on the measurement of the force acting on the mass (52) of the accelerometer (40). The collision force exacted on the occupant (110) is determined by generating a weight force necessary to prevent the accelerometer mass (52) from moving relative to the acceleration. The mechanical spring (21) and the mass (52) inside the accelerometer (40) give the accelerometer (40) a resonance. Where the resonance is define as the peak in the frequency response. The frequencies in the movement of the mass (52) must be less than the resonant frequency. However, the accelerometer sensor is so dynamic. Accordingly, the load cell (15) will receive the occupant's weight and pass on to the control module (25) that will then pass the occupant weight information to the encoder to transform the weight from analog to digital before sending it to the ROM (59). The ROM (59) will then check the software instructions about the said occupant (110) for confirmation before sending the weight information to the address line (33). The information will then be kept secured and protected from vibrations and bumps so that only the RAM (32) can fetch the data. The RAM (32) will get the occupant (110) information from the address line (33) and pass on to the CPU (26) that will then carry all the necessary computations of the occupant's mass. This information will then be sent to the accelerometer crystal (45) that will use the information to generate electrical energy that is proportionate to the weight of the occupant (110) on the seat (10). The energy generated by the crystal (45) is used to move the accelerometer mass (52), to contract the accelerometer spring (21) to set the force and speed of the airbag (1,2). When a collision is sensed by the collision sensor (75), if the magnitude of the collision exceeds a preset limit were injuries are certain, the collision sensor (75) will signal the accelerometer processor (150) that will hen signal the control module (25) to assure an occupied seat (10). The control module (25), will then signal the amplifier (20) that will then signal the gas release valve (42) and the processor (130) to initiate the volume of gas (65), that when ignited, will generate a deployment force that is proportionate to the weight of the occupant (110) and the seat (10). That is, collision sensor (75) senses collision of a prescribed magnitude and signal the control module (25). The control module (25) will then check to see which load cell (15) that is outputting signals and discriminate to ensure deployment of only the air bag (1,2) that is linked to the occupied seat (10). The control module (25) output will then pass through the specialized array to the CPU (26) before reaching the accelerometer (40). The value of the occupant's weight will initiate an equal amount of force that will then be input into the accelerometer crystal (45). This input force acting on the crystal (45) will create electrical energy that is proportionate to the said force. The electrical energy created by the crystal (45) will then be output to the accelerometer mass (52). The accelerometer mass (52), upon receiving the input electrical energy, output a force generated by the said electrical energy on the accelerometer spring (21). Said force acting on the spring is proportionate to the weight of the occupant (110). The accelerometer spring (21), after receiving its input energy from the accelerometer mass (52), initiates the air bag acceleration by contracting to a distance Z, where Z is the measured acceleration. A transient voltage suppressor (200) is located between the control module (25), and the address line (33). Recognizing that electronic equipment characteristically suffers from transient voltage spikes and that such spikes would cause abnormal readings or reactions for the RAM (32), the applicant has positioned voltage suppressor (200) to filter out transient spike phenomenon. Thus, the accurate weight value is ensured.

An electrical signal from the load cell (15) is amplified by the transistorized switches (04) and sent to the control module (25), which will assist in managing the flow of data from the load cell (15) input and output signals before the signal is sent to the CPU (26) for computation. The control module (25) discriminates between the occupant (110) side and the driver side load cell (15) to determine which air bag(s) (1, 2) are to be enabled.

The signal is next processed by the control module encoder, which will convert this signal from analog to digital before carrying further transmissions in binaries. The accelerometer (40) when amplified by the amplifier (20), sends line signals to the gas canister sliding pot (61) and the gas relay valve (42) to open to an area that is proportionate to the occupant's weight signal and release the volume of igniting gas (65) that, when ignited, generates a deployment force that is equally proportionate to the weight signal of the occupant (110). These volume of igniting gas (65), when ignited by current generated igniter (55), force a combustion inside the air bag (1,2) that will generate a deployment force that is proportional to the weight of the occupant (110) and will further hold the occupant (110) on the seat without causing any injury to the occupant (110). Because the readings from the load cell (15) are dynamic, a new acceleration value is computed each time a new signal is output from the load cell (15). The weight value from the address line (33) is used by the accelerometer (40) to apply a proportionate amount of force against the crystal (45). The energy generated by the crystals (45) displaces the accelerometer mass (52) in the accelerometer (40) to generate a corresponding amount of electrical energy therefrom, such as might occur with a piezoelectric accelerometer (40). The accelerometer crystal (45) for the accelerometer (40), when put under stress, generates electrical energy. This stress is created when the 5 milivolts and the CPU (26) output are acted upon the surface of the crystal (45), to enable pressure thereacross. Other types of accelerometer may be used, but only one would be described in this invention as a device used to compute the air bag deployment speed with a controlled energy. The electrical energy generated by the crystals (45) is recorded in milivolts. The resultant voltage developed by the crystals (45) is correlated to the necessary force required to protecting the occupant (110). This voltage is functionally transform into current (56) to variably generate the igniting current (55) and also controls the amount of energy needed to initiate movement of the sliding pot (61) and the gas release valve (42) so as to meet the smart and variable force and speed control criteria. That is, the voltage is used to generate a current that is used by the gas igniter (55) to ignite gases (65) from the canister (60) in the combustion chamber (101). The combustion chamber (101) is the inside space of the air bag (1,2), where the weight controlled igniting gas (65) and the weight generated current igniter (55) ignite when a collision of a prescribed magnitude is sensed by the collision sensor (75), to further initiate the deployment force control of the air bag (1,2). The current and the volume of igniting gas (65) employed are controlled to provide the desired expansion rate of the air bag (1, 2). Thus, there is an allowance for a changeable variation between the upper and lower threshold for the deployment force of the air bag (1, 2). Therefore, regardless of the changing weight of the occupant (110), the proper amount of the igniting gas (65) is ignited by the igniter (55) to propel the air bag (1,2) with just enough force to cushion the occupant (110), without further injuring the said occupant (110).

The control module (25) will analyze the digital electrical output from the load cell (15) as the occupant's weight and convert it into a weight value. This weight value corresponds to the weight of the occupant (110) and is then sent to the address line (33). The RAM (32) picks this weight signal from the address line (33) and passes it on to the CPU (26) to calculate the passenger's mass and all necessary calculations. The weight value and the mass value are then passed onto the accelerometer processor (150). The accelerometer (40) converts the weight value corresponding to the passenger's weight into an acceleration value corresponding to the proper amount of acceleration at which the air bag (1, 2) would have to be deployed to protect the occupant (110) when a collision of the prescribed magnitude is sensed. Since the reading from the load cell (15) is dynamic, a new acceleration value is calculated each time a new signal is output from the load cell (15). The weight value and the mass value are input in the accelerometer (40) to apply a proportionate amount of force against the crystal (45) to generate electrical energy inside the accelerometer (40). Accordingly, the voltage developed across the crystal (45) is proportionate to the amount of acceleration required to deploy the air bag (1, 2) properly. This is accomplished by displacing the mass (52) inside the accelerometer (40). These displacement amounts to having the force created by the electrical energy generated by the crystal (45), to exert said force on the accelerometer mass (52), which will then apply an equal force against the accelerometer spring (21). The force on the accelerometer spring (21) determines the deployment acceleration, and is proportionate to the force exerted by the occupant (110) on the seat (10). The accelerometer processor (150) is employed to control the acceleration of all electronic or computerized accelerometer (40), by feeding electrical energy from the load cell (15) to any processing means. The load cell (15) uses electrical means to accurately transmit information about the occupant's weight values.

The resultant voltage developed by the crystal (45) is correlated to the necessary force required to protect the occupant (110). The voltage is used to generate current to ignite the gas (65) from the gas canister (60) inside the air bag (1, 2) in the process of combustion. The current and the amount of gas employed are controlled by the CPU (26) output through the means of the occupant's weight. The CPU (26) also controls the gas discharge processor (130) that controls the gas discharge release valve (42) by means of the passenger's weight to mass value. Thus, the discharge lit or sliding pot (61) of the canister (60) uses the controlled energy from the crystal (45), through the output from the CPU (26), to provide the desired expansion rate of the air bag (1,2). The discharge lit or sliding pot (61) is defined as the outlet or a means to release a controlled volume of gas from a contained space. There is an allowance for infinite variation between an upper and lower threshold for the deployment force of the air bag (1, 2). Therefore, regardless of the weight of the occupant (110), the proper amount of gas is ignited to propel the air bag (1, 2) with just enough force to cushion the occupant (110) without any further injury.

The controlled release of gas (65) from the canister (60) is accomplished by a sliding outlet pot (61) or a discharge lit or control valve which is opened to a controlled area, to discharge gas (65) through the opening (67), a specific amount through the influence of the voltage generated by the accelerometer crystals (45), or the processed data from the CPU (26). As a result, the force of the deploying air bag (1, 2) should correctly match the force of the occupant (110) or the person on any of the front seats. In other to employ the present invention in the event of a rear end collision, the present invention uses a radar unit (70) to sense the imminence of a rear impact. This data is fed into the control module (25), which will immediately cause the deployment of the air bag (1, 2) with the proper force as discussed above. In a frontal impact of about 13.2 MPH, collision sensor (75) is activated. The speed of 13.2 MPH represents the threshold speed at which the efficacy of any air bag system should usually become activated. At collisions of below the 13.2 MPH, the air bag system tends to become less effective and expensive to deploy, thus the present invention can function even if the front impact is of extremely low speed. The preferred embodiment of the present invention would not engage until the front impact of 13.2 MPH and above is achieved. At that time the data stored in RAM (32) is used as the proper force calibration, and the air bag (1, 2) would deploy with the proper volume of propellant. The weight of the occupant (110) is correlated into an expected impact force and the desired amount of propellant or gas (65) is ignited by the current igniter (55) to provide the cushioning which balances this force, but does not over power the occupant (110) and force the occupant (110) backwards into the passenger's seat (10) at such a rate as to cause injury. To employ the present invention in the case of a rear end collision, an enhanced embodiment of the present invention includes a radar unit (70), which is used to sense the imminence of a rear impact. This rear impact data is received by the radar receiver (71) and fed into the control module (25), which will immediately discriminates between the occupied seat (10) and the unoccupied seat (10). The amplifier (20) will then receive signals from the control module (25) to amplify the deployment process of the air bag (1, 2), with the proper force as described above. The radar unit (70) and the radar receiver (71) are seen to illustrate the primary embodiment of the present invention. In the illustration, the air bag (1, 2) has two layers (3, 4) to further minimize the impact of deployment. An internal layer (3) is the base of the air bag (1, 2) itself, which is deployed according to the system described above. An external layer (4) is the cushion layer characterized by being foamy. There is a gap (6) between the two layers (3, 4). As before, the weight of the occupant (110) is correlated into an expected impact force and the desired amount of propellant or gas (65) is ignited to provide the cushioning which balances this force, but does not over power the occupant (110), and force the occupant backward into the passenger's seat (10) at such rate as to cause injury. The greater the volume of propellant or gas (65), the smaller the gap between the two air bag layers (3, 4) upon deployment with such controlled energy. Thus, the two-layer air bag (1, 2) serves to further prevent air bag deployment injuries. Another embodiment of the present invention includes several conventional sensors (7, 8) positioned on the seat belt (17) on the occupant (110) and on the air bag (1, 2) itself. The sensor (7) and (8), which are of magnetized elements, communicate so that the deployment direction of the air bag (1,2) can be minimized away from the head of the occupant (110), so as to further prevent injury. The time constant is so important in this computer device because the timing determines the performance of the advance weight responsive supplemental restraint computer system. The device uses different time constant circuit. But the applicant will address the RL time constant for now. The RL time constant is an inductor and resistor used for the design of the time circuit. When a current is flowing in the inductor, a magnetic field will build up around the inductor. If the current is interrupted, the magnetic field collapses very quickly. The magnetic field is allowed to collapse at a controlled rate by an intermediate condition between maintaining the magnetic field and allowing it to collapse rapidly. The resistor determines the rate at which the magnetic field collapses. This time constant is a measure of the time required to discharge the controlled gas (65) for the air bag deployment with a controlled energy. The time constant is a specific amount of time required to attain 100 percent of discharge of the controlled volume of gas inside the combustion chamber, initiated by the weight or calculated mass of the occupant.

The piezoelectric accelerometer (40) used for this invention generates electricity when put under mechanical stress. This stress is caused by applying pressure or force against the surface of the crystals or by twisting. The effect takes place in crystalline substances like quartz, rockelle salts tourmalines, diamonds, and sapphires, to name just a few. The pressure that results in the piezoelectric accelerometer (40) will cause an electric potential in the attached wires to enable the discharge pot or control valve of the gas canister. The occupant (110) seating on the front seat initiates the pressure. The electromotive force created by the piezoelectric accelerometer (40) is extremely small, and is measured in milivolts or microvolts. The small amount of emf created will keep this computer device safe at all time. The device utilizes built in logic in the CPU (26) to precisely control all the system that provides means for activating the air bag (1, 2). The purpose of the processors is to provide sensed information to the CPU (26) and other devices about the occupant on the seat for processing. The CPU (26) to provide variable force-speed deployment instantaneously regulates all the information. The control module (25) works together with the CPU (26) to perform all calculations. The amount of discharged gas (65) is properly controlled to protect passengers of all sizes. The discharge and combustion occurs in variable mode due to the changing occupant's (110).

In deciding the speed at which the computer logic should respond to the occupant's weight value during collision, the decimal readings will be transformed into binaries. The electronic switches (04) will then recognize the binaries as OFF and ON switches that will represent “1s” and “0s”. Where the 0s will represent OFF signals and the 1s will represent ON signals. The OFF is an open circuit and an ON is a closed circuit. Below are the weight values in decimals and binary representation of the OFF and ON electronic switching. The binaries will logically be used to tell the computer system the number of switches that need to be turn ON and OFF to influence accurate responses to the weight signals. Also, it will energize the active devices that will initiate a controlled energy for the smart deployment of the air bag (1, 2) without causing further injury to the occupant (110). This advanced and smart technology will appreciate weight sizes of any degree and fully protect the occupant (110) with a controlled energy generated from the said weight value of the said occupant (110). As could be seen below, are some of the few weight sizes that shows how fast it will take the computer to respond to the weights of the occupants by turning the switches ON and OFF on time, for the computer to timely speed up the immediate responses when a collision is sensed. This computer uses logical functions to timely open and closes all circuits with these switches. These logic depend on the switches to open and close on time for this intelligent device to know who the occupant is, before activating the deployment force of the air bag which will deploy from a controlled energy that depend on the weight of the said occupant. The weights are promptly transmitted to all the intelligent devices used in this invention to influence the controlled energy that will enforce deployments that are totally dependant on the occupant's weight value. The switches are activated when the collision sensor senses collision. The arrangement of the electronically conducting line signals for the entire circuits is used for signaling the RAM and the computer CPU to initiate the controlled deployment.

It is now understood that the present invention is not limited to the sole embodiment described above, but encompasses any and all embodiment within the scope of the following claims.

A1:A501

Weight In Decimals Weight In Binaries “Off & On Switches” Speed

“Minimum Speed For Deployment”

| | | |
|---|---|---|
| 1 | 1 | 13 MPH |
| 2 | 10 | 13 MPH |
| 3 | 11 | 13 MPH |
| 4 | 100 | 13 MPH |
| 5 | 101 | 13 MPH |
| 6 | 110 | 13 MPH |
| 7 | 111 | 13 MPH |
| 8 | 1000 | 13 MPH |
| 9 | 1001 | 13 MPH |
| 10 | 1010 | 13 MPH |
| 11 | 1011 | 13 MPH |
| 12 | 1100 | 13 MPH |
| 13 | 1101 | 13 MPH |
| 14 | 1110 | 13 MPH |
| 15 | 1111 | 13 MPH |
| 16 | 10000 | 13 MPH |
| 17 | 10001 | 13 MPH |
| 18 | 10010 | 13 MPH |
| 19 | 10011 | 13 MPH |
| 20 | 10100 | 13 MPH |
| 21 | 10101 | 13 MPH |
| 22 | 10110 | 13 MPH |
| 23 | 10111 | 13 MPH |
| 24 | 11000 | 13 MPH |
| 25 | 11001 | 13 MPH |
| 26 | 11010 | 13 MPH |
| 27 | 11011 | 13 MPH |
| 28 | 11100 | 13 MPH |
| 29 | 11101 | 13 MPH |
| 30 | 11110 | 13 MPH |
| 31 | 11111 | 13 MPH |
| 32 | 100000 | 13 MPH |
| 33 | 100001 | 13 MPH |
| 34 | 100010 | 13 MPH |
| 35 | 100011 | 13 MPH |
| 36 | 100100 | 13 MPH |
| 37 | 100101 | 13 MPH |
| 38 | 100110 | 13 MPH |
| 39 | 100111 | 13 MPH |
| 40 | 101000 | 13 MPH |
| 41 | 101001 | 13 MPH |
| 42 | 101010 | 13 MPH |
| 43 | 101011 | 13 MPH |
| 44 | 101100 | 13 MPH |
| 45 | 101101 | 13 MPH |
| 46 | 101110 | 13 MPH |
| 47 | 101111 | 13 MPH |
| 48 | 110000 | 13 MPH |
| 49 | 110001 | 13 MPH |
| 50 | 110010 | 13 MPH |
| 51 | 110011 | 13 MPH |
| 52 | 110100 | 13 MPH |
| 53 | 110101 | 13 MPH |
| 54 | 110110 | 13 MPH |
| 55 | 110111 | 13 MPH |
| 56 | 111000 | 13 MPH |
| 57 | 111001 | 13 MPH |
| 58 | 111010 | 13 MPH |
| 59 | 111011 | 13 MPH |
| 60 | 111100 | 13 MPH |
| 61 | 111101 | 13 MPH |
| 62 | 111110 | 13 MPH |
| 63 | 111111 | 13 MPH |
| 64 | 1000000 | 13 MPH |
| 65 | 1000001 | 13 MPH |
| 66 | 1000010 | 13 MPH |
| 67 | 1000011 | 13 MPH |
| 68 | 1000100 | 13 MPH |
| 69 | 1000101 | 13 MPH |
| 70 | 1000110 | 13 MPH |
| 71 | 1000111 | 13 MPH |
| 72 | 1001000 | 13 MPH |
| 73 | 1001001 | 13 MPH |
| 74 | 1001010 | 13 MPH |
| 75 | 1001011 | 13 MPH |
| 76 | 1001100 | 13 MPH |
| 77 | 1001101 | 13 MPH |
| 78 | 1001110 | 13 MPH |
| 79 | 1001111 | 13 MPH |
| 80 | 1010000 | 13 MPH |
| 81 | 1010001 | 13 MPH |
| 82 | 1010010 | 13 MPH |
| 83 | 1010011 | 13 MPH |
| 84 | 1010100 | 13 MPH |
| 85 | 1010101 | 13 MPH |
| 86 | 1010110 | 13 MPH |
| 87 | 1010111 | 13 MPH |
| 88 | 1011000 | 13 MPH |
| 89 | 1011001 | 13 MPH |
| 90 | 1011010 | 13 MPH |
| 91 | 1011011 | 13 MPH |
| 92 | 1011100 | 13 MPH |
| 93 | 1011101 | 13 MPH |
| 94 | 1011110 | 13 MPH |
| 95 | 1011111 | 13 MPH |
| 96 | 1100000 | 13 MPH |
| 97 | 1100001 | 13 MPH |
| 98 | 1100010 | 13 MPH |
| 99 | 1100011 | 13 MPH |
| 100 | 1100100 | 13 MPH |
| 101 | 1100101 | 13 MPH |
| 102 | 1100110 | 13 MPH |
| 103 | 1100111 | 13 MPH |
| 104 | 1101000 | 13 MPH |
| 105 | 1101001 | 13 MPH |
| 106 | 1101010 | 13 MPH |
| 107 | 1101011 | 13 MPH |
| 108 | 1101100 | 13 MPH |
| 109 | 1101101 | 13 MPH |
| 110 | 1101110 | 13 MPH |
| 111 | 1101111 | 13 MPH |
| 112 | 1110000 | 13 MPH |
| 113 | 1110001 | 13 MPH |
| 114 | 1110010 | 13 MPH |
| 115 | 1110011 | 13 MPH |
| 116 | 1110100 | 13 MPH |
| 117 | 1110101 | 13 MPH |
| 118 | 1110110 | 13 MPH |
| 119 | 1110111 | 13 MPH |
| 120 | 1111000 | 13 MPH |
| 121 | 1111001 | 13 MPH |
| 122 | 1111010 | 13 MPH |
| 123 | 1111011 | 13 MPH |
| 124 | 1111100 | 13 MPH |
| 125 | 1111101 | 13 MPH |
| 126 | 1111110 | 13 MPH |
| 127 | 1111111 | 13 MPH |
| 128 | 10000000 | 13 MPH |
| 129 | 10000001 | 13 MPH |
| 130 | 10000010 | 13 MPH |
| 131 | 10000011 | 13 MPH |
| 132 | 10000100 | 13 MPH |
| 133 | 10000101 | 13 MPH |
| 134 | 10000110 | 13 MPH |
| 135 | 10000111 | 13 MPH |
| 136 | 10001000 | 13 MPH |
| 137 | 10001001 | 13 MPH |
| 138 | 10001010 | 13 MPH |
| 139 | 10001011 | 13 MPH |
| 140 | 10001100 | 13 MPH |
| 141 | 10001101 | 13 MPH |
| 142 | 10001110 | 13 MPH |
| 143 | 10001111 | 13 MPH |
| 144 | 10010000 | 13 MPH |
| 145 | 10010001 | 13 MPH |
| 146 | 10010010 | 13 MPH |
| 147 | 10010011 | 13 MPH |
| 148 | 10010100 | 13 MPH |
| 149 | 10010101 | 13 MPH |
| 150 | 10010110 | 13 MPH |
| 151 | 10010111 | 13 MPH |
| 152 | 10011000 | 13 MPH |
| 153 | 10011001 | 13 MPH |
| 154 | 10011010 | 13 MPH |
| 155 | 10011011 | 13 MPH |
| 156 | 10011100 | 13 MPH |
| 157 | 10011101 | 13 MPH |
| 158 | 10011110 | 13 MPH |
| 159 | 10011111 | 13 MPH |
| 160 | 10100000 | 13 MPH |
| 161 | 10100001 | 13 MPH |
| 162 | 10100010 | 13 MPH |
| 163 | 10100011 | 13 MPH |
| 164 | 10100100 | 13 MPH |
| 165 | 10100101 | 13 MPH |
| 166 | 10100110 | 13 MPH |
| 167 | 10100111 | 13 MPH |
| 168 | 10101000 | 13 MPH |
| 169 | 10101001 | 13 MPH |
| 170 | 10101010 | 13 MPH |
| 171 | 10101011 | 13 MPH |
| 172 | 10101100 | 13 MPH |
| 173 | 10101101 | 13 MPH |
| 174 | 10101110 | 13 MPH |
| 175 | 10101111 | 13 MPH |
| 176 | 10110000 | 13 MPH |
| 177 | 10110001 | 13 MPH |
| 178 | 10110010 | 13 MPH |
| 179 | 10110011 | 13 MPH |
| 180 | 10110100 | 13 MPH |
| 181 | 10110101 | 13 MPH |
| 182 | 10110110 | 13 MPH |
| 183 | 10110111 | 13 MPH |
| 184 | 10111000 | 13 MPH |
| 185 | 10111001 | 13 MPH |
| 186 | 10111010 | 13 MPH |
| 187 | 10111011 | 13 MPH |
| 188 | 10111100 | 13 MPH |
| 189 | 10111101 | 13 MPH |
| 190 | 10111110 | 13 MPH |
| 191 | 10111111 | 13 MPH |
| 192 | 11000000 | 13 MPH |
| 193 | 11000001 | 13 MPH |
| 194 | 11000010 | 13 MPH |
| 195 | 11000011 | 13 MPH |
| 196 | 11000100 | 13 MPH |
| 197 | 11000101 | 13 MPH |
| 198 | 11000110 | 13 MPH |
| 199 | 11000111 | 13 MPH |
| 200 | 11001000 | 13 MPH |
| 201 | 11001001 | 13 MPH |
| 202 | 11001010 | 13 MPH |
| 203 | 11001011 | 13 MPH |
| 204 | 11001100 | 13 MPH |
| 205 | 11001101 | 13 MPH |
| 206 | 11001110 | 13 MPH |
| 207 | 11001111 | 13 MPH |
| 208 | 11010000 | 13 MPH |
| 209 | 11010001 | 13 MPH |
| 210 | 11010010 | 13 MPH |
| 211 | 11010011 | 13 MPH |
| 212 | 11010100 | 13 MPH |
| 213 | 11010101 | 13 MPH |
| 214 | 11010110 | 13 MPH |
| 215 | 11010111 | 13 MPH |
| 216 | 11011000 | 13 MPH |
| 217 | 11011001 | 13 MPH |
| 218 | 11011010 | 13 MPH |
| 219 | 11011011 | 13 MPH |
| 220 | 11011100 | 13 MPH |
| 221 | 11011101 | 13 MPH |
| 222 | 11011110 | 13 MPH |
| 223 | 11011111 | 13 MPH |
| 224 | 11100000 | 13 MPH |
| 225 | 11100001 | 13 MPH |
| 226 | 11100010 | 13 MPH |
| 227 | 11100011 | 13 MPH |
| 228 | 11100100 | 13 MPH |
| 229 | 11100101 | 13 MPH |
| 230 | 11100110 | 13 MPH |
| 231 | 11100111 | 13 MPH |
| 232 | 11101000 | 13 MPH |
| 233 | 11101001 | 13 MPH |
| 234 | 11101010 | 13 MPH |
| 235 | 11101011 | 13 MPH |
| 236 | 11101100 | 13 MPH |
| 237 | 11101101 | 13 MPH |
| 238 | 11101110 | 13 MPH |
| 239 | 11101111 | 13 MPH |
| 240 | 11110000 | 13 MPH |
| 241 | 11110001 | 13 MPH |
| 242 | 11110010 | 13 MPH |
| 243 | 11110011 | 13 MPH |
| 244 | 11110100 | 13 MPH |
| 245 | 11110101 | 13 MPH |
| 246 | 11110110 | 13 MPH |
| 247 | 11110111 | 13 MPH |
| 248 | 11111000 | 13 MPH |
| 249 | 11111001 | 13 MPH |
| 250 | 11111010 | 13 MPH |
| 251 | 11111011 | 13 MPH |
| 252 | 11111100 | 13 MPH |
| 253 | 11111101 | 13 MPH |
| 254 | 11111110 | 13 MPH |
| 255 | 11111111 | 13 MPH |
| 256 | 100000000 | 13 MPH |
| 257 | 100000001 | 13 MPH |
| 258 | 100000010 | 13 MPH |
| 259 | 100000011 | 13 MPH |
| 260 | 100000100 | 13 MPH |
| 261 | 100000101 | 13 MPH |
| 262 | 100000110 | 13 MPH |
| 263 | 100000111 | 13 MPH |
| 264 | 100001000 | 13 MPH |
| 265 | 100001001 | 13 MPH |
| 266 | 100001010 | 13 MPH |
| 267 | 100001011 | 13 MPH |
| 268 | 100001100 | 13 MPH |
| 269 | 100001101 | 13 MPH |
| 270 | 100001110 | 13 MPH |
| 271 | 100001111 | 13 MPH |
| 272 | 100010000 | 13 MPH |
| 273 | 100010001 | 13 MPH |
| 274 | 100010010 | 13 MPH |
| 275 | 100010011 | 13 MPH |
| 276 | 100010100 | 13 MPH |
| 277 | 100010101 | 13 MPH |
| 278 | 100010110 | 13 MPH |
| 279 | 100010111 | 13 MPH |
| 280 | 100011000 | 13 MPH |
| 281 | 100011001 | 13 MPH |
| 282 | 100011010 | 13 MPH |
| 283 | 100011011 | 13 MPH |
| 284 | 100011100 | 13 MPH |
| 285 | 100011101 | 13 MPH |
| 286 | 100011110 | 13 MPH |
| 287 | 100011111 | 13 MPH |
| 288 | 100100000 | 13 MPH |
| 289 | 100100001 | 13 MPH |
| 290 | 100100010 | 13 MPH |
| 291 | 100100011 | 13 MPH |
| 292 | 100100100 | 13 MPH |
| 293 | 100100101 | 13 MPH |
| 294 | 100100110 | 13 MPH |
| 295 | 100100111 | 13 MPH |
| 296 | 100101000 | 13 MPH |
| 297 | 100101001 | 13 MPH |
| 298 | 100101010 | 13 MPH |
| 299 | 100101011 | 13 MPH |
| 300 | 100101100 | 13 MPH |
| 301 | 100101101 | 13 MPH |
| 302 | 100101110 | 13 MPH |
| 303 | 100101111 | 13 MPH |
| 304 | 100110000 | 13 MPH |
| 305 | 100110001 | 13 MPH |
| 306 | 100110010 | 13 MPH |
| 307 | 100110011 | 13 MPH |
| 308 | 100110100 | 13 MPH |
| 309 | 100110101 | 13 MPH |
| 310 | 100110110 | 13 MPH |
| 311 | 100110111 | 13 MPH |
| 312 | 100111000 | 13 MPH |
| 313 | 100111001 | 13 MPH |
| 314 | 100111010 | 13 MPH |
| 315 | 100111011 | 13 MPH |
| 316 | 100111100 | 13 MPH |
| 317 | 100111101 | 13 MPH |
| 318 | 100111110 | 13 MPH |
| 319 | 100111111 | 13 MPH |
| 320 | 101000000 | 13 MPH |
| 321 | 101000001 | 13 MPH |
| 322 | 101000010 | 13 MPH |
| 323 | 101000011 | 13 MPH |
| 324 | 101000100 | 13 MPH |
| 325 | 101000101 | 13 MPH |
| 326 | 101000110 | 13 MPH |
| 327 | 101000111 | 13 MPH |
| 328 | 101001000 | 13 MPH |
| 329 | 101001001 | 13 MPH |
| 330 | 101001010 | 13 MPH |
| 331 | 101001011 | 13 MPH |
| 332 | 101001100 | 13 MPH |
| 333 | 101001101 | 13 MPH |
| 334 | 101001110 | 13 MPH |
| 335 | 101001111 | 13 MPH |
| 336 | 101010000 | 13 MPH |
| 337 | 101010001 | 13 MPH |
| 338 | 101010010 | 13 MPH |
| 339 | 101010011 | 13 MPH |
| 340 | 101010100 | 13 MPH |
| 341 | 101010101 | 13 MPH |
| 342 | 101010110 | 13 MPH |
| 343 | 101010111 | 13 MPH |
| 344 | 101011000 | 13 MPH |
| 345 | 101011001 | 13 MPH |
| 346 | 101011010 | 13 MPH |
| 347 | 101011011 | 13 MPH |
| 348 | 101011100 | 13 MPH |
| 349 | 101011101 | 13 MPH |
| 350 | 101011110 | 13 MPH |
| 351 | 101011111 | 13 MPH |
| 352 | 101100000 | 13 MPH |
| 353 | 101100001 | 13 MPH |
| 354 | 101100010 | 13 MPH |
| 355 | 101100011 | 13 MPH |
| 356 | 101100100 | 13 MPH |
| 357 | 101100101 | 13 MPH |
| 358 | 101100110 | 13 MPH |
| 359 | 101100111 | 13 MPH |
| 360 | 101101000 | 13 MPH |
| 361 | 101101001 | 13 MPH |
| 362 | 101101010 | 13 MPH |
| 363 | 101101011 | 13 MPH |
| 364 | 101101100 | 13 MPH |
| 365 | 101101101 | 13 MPH |
| 366 | 101101110 | 13 MPH |
| 367 | 101101111 | 13 MPH |
| 368 | 101110000 | 13 MPH |
| 369 | 101110001 | 13 MPH |
| 370 | 101110010 | 13 MPH |
| 371 | 101110011 | 13 MPH |
| 372 | 101110100 | 13 MPH |
| 373 | 101110101 | 13 MPH |
| 374 | 101110110 | 13 MPH |
| 375 | 101110111 | 13 MPH |
| 376 | 101111000 | 13 MPH |
| 377 | 101111001 | 13 MPH |
| 378 | 101111010 | 13 MPH |
| 379 | 101111011 | 13 MPH |
| 380 | 101111100 | 13 MPH |
| 381 | 101111101 | 13 MPH |
| 382 | 101111110 | 13 MPH |
| 383 | 101111111 | 13 MPH |
| 384 | 110000000 | 13 MPH |
| 385 | 110000001 | 13 MPH |
| 386 | 110000010 | 13 MPH |
| 387 | 110000011 | 13 MPH |
| 388 | 110000100 | 13 MPH |
| 389 | 110000101 | 13 MPH |
| 390 | 110000110 | 13 MPH |
| 391 | 110000111 | 13 MPH |
| 392 | 110001000 | 13 MPH |
| 393 | 110001001 | 13 MPH |
| 394 | 110001010 | 13 MPH |
| 395 | 110001011 | 13 MPH |
| 396 | 110001100 | 13 MPH |
| 397 | 110001101 | 13 MPH |
| 398 | 110001110 | 13 MPH |
| 399 | 110001111 | 13 MPH |
| 400 | 110010000 | 13 MPH |
| 401 | 110010001 | 13 MPH |
| 402 | 110010010 | 13 MPH |
| 403 | 110010011 | 13 MPH |
| 404 | 110010100 | 13 MPH |
| 405 | 110010101 | 13 MPH |
| 406 | 110010110 | 13 MPH |
| 407 | 110010111 | 13 MPH |
| 408 | 110011000 | 13 MPH |
| 409 | 110011001 | 13 MPH |
| 410 | 110011010 | 13 MPH |
| 411 | 110011011 | 13 MPH |
| 412 | 110011100 | 13 MPH |
| 413 | 110011101 | 13 MPH |
| 414 | 110011110 | 13 MPH |
| 415 | 110011111 | 13 MPH |
| 416 | 110100000 | 13 MPH |
| 417 | 110100001 | 13 MPH |
| 418 | 110100010 | 13 MPH |
| 419 | 110100011 | 13 MPH |
| 420 | 110100100 | 13 MPH |
| 421 | 110100101 | 13 MPH |
| 422 | 110100110 | 13 MPH |
| 423 | 110100111 | 13 MPH |
| 424 | 110101000 | 13 MPH |
| 425 | 110101001 | 13 MPH |
| 426 | 110101010 | 13 MPH |
| 427 | 110101011 | 13 MPH |
| 428 | 110101100 | 13 MPH |
| 429 | 110101101 | 13 MPH |
| 430 | 110101110 | 13 MPH |
| 431 | 110101111 | 13 MPH |
| 432 | 110110000 | 13 MPH |
| 433 | 110110001 | 13 MPH |
| 434 | 110110010 | 13 MPH |
| 435 | 110110011 | 13 MPH |
| 436 | 110110100 | 13 MPH |
| 437 | 110110101 | 13 MPH |
| 438 | 110110110 | 13 MPH |
| 439 | 110110111 | 13 MPH |
| 440 | 110111000 | 13 MPH |
| 441 | 110111001 | 13 MPH |
| 442 | 111000100 | 13 MPH |
| 443 | 110111011 | 13 MPH |
| 444 | 110111100 | 13 MPH |
| 445 | 110111101 | 13 MPH |
| 446 | 110111110 | 13 MPH |
| 447 | 110111111 | 13 MPH |
| 448 | 111000000 | 13 MPH |
| 449 | 111000001 | 13 MPH |
| 450 | 111000010 | 13 MPH |
| 451 | 111000011 | 13 MPH |
| 452 | 111000100 | 13 MPH |
| 453 | 111000101 | 13 MPH |
| 454 | 111000110 | 13 MPH |
| 455 | 111000111 | 13 MPH |
| 456 | 111001000 | 13 MPH |
| 457 | 111001001 | 13 MPH |
| 458 | 111001010 | 13 MPH |
| 459 | 111001011 | 13 MPH |
| 460 | 111001100 | 13 MPH |

In deciding the speed at which the computer logic should respond to the occupant's weight value during collision, the decimal digital readings will be transformed into binaries. The electronic switches will then recognize the binaries as OFF and ON switches that will represent “1s” and “0s”. Where the 0s will represent OFF signals and the 1s will represent on signals. The OFF is an opened circuit and the ON is a closed circuit. The above are the weight values in decimals and binaries representation of the OFF and ON electronics witching that will logically tell the computer system the number of switches that need to be turn ON or OFF to influence accurate response to the weight signals, and energize the active devices that will initiate a controlled energy for the smart deployment of the airbag without causing further injury to the occupant. In addition, this advance and smart technology will appreciate weight value of any size to fully protect the occupants with a controlled energy generated from the said weight value of the occupant. The above weight sizes shows how fast it will take the computer to timely respond to the weights of the occupants by turning the switches ON and OFF on time, for the said computer to timely speed-up to the immediate response when a collision is sensed. The said computer uses logic functions to timely open and closes all circuits with these switches. The logic depend on the switches to open and close on time for this intelligent device to know who the occupant is, and activate the deployment of the airbags that will deploy from a controlled energy that depend on the weight of the said occupants. The weights are promptly transmitted to all the intelligent devices used in this invention to influence the controlled energy that will enforce deployment that is totally dependant on the occupant's weight value.

It is now understood that the present invention is not limited to the sole embodiment described above, but encompasses any and all embodiment within the scope of the following claims:

What is claimed is:

1. A supplemental restraint system comprising:
means for sensing weight, generating weight signal corresponding to a weight of an occupant (110) on the seat (10);
a central processing unit (26), responsive to a digital signal, which has been amplified and converted from said weight signal, generating a mass value;
an accelerometer (40), responsive to said mass value, generating electrical energy corresponding to said mass value;
a gas canister (60), defining a combustion chamber (101), responsive to said accelerometer (40), releasing a gas (65), into said combustion chamber (101) at a rate corresponding to said mass value,
a gas current igniter (55), generating igniting electrical energy, said electrical energy igniting a volume of discharge gas (55) with electrical energy equivalent to the volume of said discharged gas (65), and empowering deployment of an airbag (1,2) at a rate corresponding to said mass value.

2. A supplemental restraint system as claimed in 1, wherein said generated weight signal defines a mechanism for transforming said generated weight into a controlled energy for controlling deployment of an airbag (1, 2).

3. A supplemental restraint system according to either of claims 1 or 2, wherein said controlled energy is responsive to enabling an accelerometer operation and the controlled release of igniting gas (65).

4. A supplemental restraint system as claimed in 3, wherein said accelerometer operation or a controlled energy from at least a sensor, coordinates and controls the gas opening (67) and the igniter (55), for enabling a proportionate airbag deployment force.

5. A supplemental restraint system according to either of claims 3 or 4, including a sliding outlet port (61), controlled by said accelerometer (40) or a controlled energy source, and releasing gas (65) into said combustion chamber (101), at a rate corresponding to said mass value.

6. A supplemental restraint system as claimed in 1, further comprising a device for processing said body weight into calculated mass value, said mass value responsive to, but not limited to enabling a second device, for generating a second electrical energy, said second energy corresponding to the first generated by the load cell (15).

7. A supplemental restraint system according to either of claims 1 or 6, further comprising a CPU (26) for calculating said occupant's body mass value and being in communication with signal processing means, said signal processing means not excluding any of microprocessors, for processing digital and analog data for the control of airbag deployment force.

8. A supplemental restraint system according to either of claims 6 or 7, further comprising a device for enabling said second electrical energy on a spring (21), such that said spring reaction enabled by the electrical energy, motions a mass body (52), such that each distance traveled by said mass body (52) enable a variable acceleration, corresponding to a variable deployment force.

9. A supplemental restraint system as claimed in 8, further comprising an amplifying device (20) for amplifying signal processing devices when a collision is eminent.

10. A supplemental restraint system comprising:
an air bag (1,2);
means for sensing weight, generating a weight signal corresponding to a weight of an occupant (110) on the seat (10);
a decoder, responsive for analog to digital signals which has been amplified and converted from said weight signal, generating a mass value;
an accelerometer (40), responsive to said mass value, generating electrical energy corresponding to said mass value; and
means for controlling a force exerted by said air bag (1,2) upon expansion so that said force is
Proportionate to said mass of said occupant (110);
Wherein said means for controlling said force of said air bag (1, 2) is infinitely variable between an upper and lower threshold.

11. A supplemental restraint system as claimed in 10, further comprising: an internal layer (3); an external layer (4), having extremely foamy characteristics between said external layer (4) and the internal layer (3), for cushioning upon deployment of airbag (1, 2), corresponding to the weight of the occupant (110).

12. A supplemental restraint system according to either of claims 10 or 11, further comprising plurality load cell (15), interposed between plurality seat mounting frame and the floor (100) of the vehicle, generating a second weight signal corresponding to plurality weight of a second occupant (110) on the second seat (10).

13. A supplemental restraint system as claimed in 10, further comprising a controller (25) of type thyristor, but not limited to said type of class silicon control module, electrically connected to said load cell (15) and said second load cell (15), said load cell being plurality of load cells for distinguishing between said weight and said second weight; wherein said controller (25) enables the airbag responsive to said weight signal, and said controller (25) enables a second airbag responsive to said weight signal.

14. A supplemental restraint system as claimed in 10, wherein said accelerometer including a mass body (52), selectively engaged with a crystal (45) with a force corresponding to said mass value, said crystal (45) generates a voltage across a surface thereof corresponding to said mass value.

15. Means for controlling the reaction force of an occupant safety restraint system for a seated occupant, said means comprising;
a weight sensor (15) for determining the weight of a seating occupant (110) and generating an output signal indicative thereof;
the weight sensor (15), including a device (11), for transforming said body weight signal into electrical energy, corresponding to the weight of said occupant (110), sampling input and output signals to plurality of sensors such that the occupant applied force on the surfaces of the seat (10) and the floor (100) of the vehicle are measured to enable the body mass calculation.

16. Means for controlling the deployment force of a safety restraint system as claimed in 15, comprising an airbag deployment controller wherein at least one of the plurality sensors is either of resistance pressure sensor or inductance pressure sensor.

17. Means for controlling deployment force of a safety restraint system according to either of claims 15 or 16, further includes, but not limited to capacitance pressure sensor.

18. A controlling means according to claim 15, including a radar unit (70), said radar unit not excluding sensors, responsive to rear end collision, triggering deployment of said airbag (1,2).

19. Means as claimed in 15, further comprising a load cell (15) with strain gages (11) bonded inside, and generating electrical energy when strained and or under load.

20. Means, according to either of claims 15 to 19, further comprising a sensor with incorporated software program inside housing, for calculating occupant's weight to mass transformation.

21. Means, as claimed in 20, further comprising a sensing device that houses electrical resistance device for transforming body weight into electrical energy, for coordinating electromechanical reaction devices, mounted between the mounting surface of the occupant's seat (10) and the floor (100).

22 A controller for a supplemental restraint system wherein said controller comprising;
means, such that said means is dependent on an occupant's presence, for measuring the crash severity and the speed of the vehicle to enable a single or plurality of airbag deployments.

23 A controller for a supplemental restraint system as claimed in 22, wherein said controller enables airbag deployment forces indicative of the speed of the vehicle and the severity of the crash.

24 A supplemental restraint system comprising;
means for precisely monitoring the initial weight of a seated occupant (110) and the weight of a changing occupant, for controlling the deployment force of an airbag (1,2), comprising;
(a). an address line (33), being a reference storage memory or medium for storing actual weight at initial sitting, said memory not limited to either RAM (32) or ROM (59);
(b). an EPROM, for controlling data about a changing occupant (110) at the address line (33);
\mathring{c}. A microprocessor means, for communicating with plurality of signal sensors, said sensors being in circuit communication with plurality of other signal processors, and transistorize switches (04), through which an airbag deployment or any restraint is enabled.

25 A supplemental restraint system according to claim 24, including an impact collision sensor (75) adapted to initiate response of said supplemental restraint system, for enabling deployment force of airbag (1,2), wherein said deployment force is dependent on said collision force and said speed of the vehicle.

26. A supplemental restraint system including sensor (7), mounted on a seatbelt provided for the seat and a sensor (8) mounted on the airbag, cooperatively influencing deployment direction of the airbag.

27 A supplemental restraint system for an airbag comprising a voltage suppressor (200) for filtering out transient phenomenon, said phenomenon is excluded and unwanted from adoption into the airbag circuitry.

28 A supplemental restraint system comprising
a load cell (15) embedded within structural mounting surface of a vehicle seat (10) and the vehicle floor, for measuring weights of occupants (110) on said vehicle seats, wherein said load cell (15) generates electrical signals or pulses corresponding only to the weight of said occupant (110) on the seat (10);
a CPU (26), responsive to said weight signal, generating a mass value;
memory means for storing current value of said CPU (26), said memory is updated each time said CPU generates a new value;
an accelerometer (40) responsive for converting said unit of mass stored in said memory into electrical energy proportionate to a force generated by said occupant (110) on said seat;
an air bag (1,2) and gas canister defining a combustion chamber, responsive to said accelerometer (40), wherein said accelerometer (40) generates a controlled energy to control said canister sliding pot, releasing a controlled and variable amount of gas into said combustion chamber, wherein said controlled energy is converted into an igniting current, said igniting current igniting said gas and deploying at least an air bag (1,2) at a rate corresponding to said mass value;
an impact collision sensor (75) initiates a response of said supplemental restraint system, enabling signal communication so that a force generated by an expansion of said air bag (1,2) is correlatively matched to said force generated by said occupant (110) and the said impact force.

29. A supplemental restraint system of claim 28, further including; a digital to analog converter, for converting said amplified signal to digital signal communication.

30. A supplemental restraint system of claim 28, further including; said load cell (15) being formed from machined steel beam having multiple strain gauges (11) bonded in an interior of said load cell (15).

31. A supplemental restraint system according to claim 28, further comprising; said accelerometer having a mass which is selectively engaged with a crystal, wherein a force generated on the surface of said crystal by said mass is proportionate to said force of said occupant in said seat; said crystal develops said control energy across the said surface as a result of said force generated by said mass.

32. A supplemental restraint system according to claim 28, further including;
said means for determining said mass of said occupant (110) being adapted to measure a weight of a seat as well as of said occupant (110), wherein said weight of said seat (10) forms a threshold; means for analyzing said threshold so that said air bag (1,2) is only deployed when said threshold is exceeded.

33. A supplemental restraint system according to claim 28, wherein the air bag (1,2) comprises;
An internal layer (3), and an external layer (4), having extremely foamy characteristics, mounted on said internal layer, defining a cushioning there between.
